(19) United States
(12) Patent Application Publication
(10) Pub. No.: US 2016/0365708 A1
(43) Pub. Date: Dec. 15, 2016

(54) ENERGY DISTRIBUTION SYSTEM, ENERGY DISTRIBUTION DEVICE AND INSTALLATION METHOD

(71) Applicant: Sonnenbatterie GmbH, Wildpoldsried (DE)

(72) Inventors: Torsten STIEFENHOFER, Wildpoldsried (DE); Carlos RESTREPO, Atlanta, GA (US)

(73) Assignee: SONNENBATTERIE GMBH, Wildpoldsried (DE)

(21) Appl. No.: 14/735,301

(22) Filed: Jun. 10, 2015

(51) Int. Cl. H02B 1/04; H02J 3/00; H02M 7/42; H02B 3/00; H02B 1/42

(52) U.S. Cl. CPC H02B 1/04; H02B 3/00; H02B 1/42; H02M 7/42; H02J 3/005

(57) ABSTRACT

An energy distribution system, an energy distribution device and an installation method are provided. The energy distribution device comprises a distribution board and a power inverter, which are integrated together inside a single enclosure for ease of installation and upgrade of the energy distribution system.

### FIELD OF THE INVENTION

The invention relates to an energy distribution system, to an energy distribution device and to an installation method.

### BACKGROUND OF THE INVENTION

The rising popularity of alternative sources of electric energy has also led to an increase in the number of local energy sources. More and more individual buildings are being upgraded in particular with photovoltaic (PV) modules. These PV modules supply part of the electrical power needed by appliances inside or at the building, in order to lower the amount of power that needs to be drawn from an external power grid, thus reducing the electricity costs of the building. Furthermore, during times when the PV module is able to supply more electrical power than the appliances of the building can consume, either because only a few appliances are turned on or because there is a momentary overabundance of sunshine, excess power from the PV module may be fed to the external power grid. In this case, the owner of the PV module may receive compensation from the power grid company, leading to an even higher reduction of her or his electrical bill. In addition, a battery system is often installed alongside the PV module at the building, in order to store excess electrical power from the PV module and supply the stored electrical power to the appliances at a later time, for example during the night when the PV module doesn't produce as much power.

Such setups are more complicated than the traditional energy supply system, in which the appliances of a building receive their electrical power exclusively from the external power grid through a distribution panel, which contains a circuit breaker or fuse for every appliance or for a group of appliances connected to a shared socket or placed in a room of the building. The energy distribution systems for buildings having a PV module, a battery system and possible other electrical power related structures are more complex. This means that the installation of a PV module and a battery system requires the rewiring of the energy distribution system, for example by adding additional switches, distribution panels, power meters etc. Further rewiring of the power distribution system and even of the appliances might be necessary in order to allow for smart control of the appliances for optimizing the energy consumption.

This makes the installation of modern power systems time consuming and expensive. Often experts with very extensive training are the only ones who can perform this task. Furthermore, the additional devices take up much space inside or around the building.

It is thus an objective of the present invention to provide devices and methods that simplify the process of retrofitting a building with modern local energy sources. A further objective of the invention is to provide a reliable energy distribution system for a building containing electrical appliances or load.

### SUMMARY OF THE INVENTION

In order to achieve the above-mentioned object, according to one aspect of the invention, an energy distribution system is provided. The energy distribution system is installed at or inside a building, which might be a private home, an apartment building, or a commercial building such as a factory. The system comprises a first distribution board, which encompasses multiple circuit breakers. This first distribution board may be a standard distribution panel or wired similar to a standard distribution panel, which divides incoming power to different parts of the building.

Said first distribution board is connected to an external power grid and to multiple loads, such that each of said multiple loads receives electrical power from said external power grid through a corresponding one of said multiple circuit breakers. The loads are in particular appliances inside or about the building, such as HVAC devices, dishwashers, washing machines, dryers, refrigerators etc. In a factory setting, they might include machinery and production systems.

The connection between the first distribution board and the external power grid may not be a direct connection. In fact, most of the time, there will be other components of the system placed between the first distribution board and the external power grid. These other components may in particular be switches and/or other distribution boards, as will be explained later on. Furthermore, the building's electrical system might comprise a local power grid, which is connected to the external power grid. In this case, the first distribution board might be connected to the local power grid and through the local power grid also to the external power grid.

The energy distribution system for the building further comprises a power inverter and a battery system. The battery system is configured to store excess electrical power and to supply stored electrical power to said multiple loads or appliances. The battery system accepts and outputs a direct current (DC) power, while the loads are designed to run on alternating current (AC) power provided by the external power grid. Therefore, the power inverter is placed between the battery system and the first distribution board to convert the DC power output from the battery system to an AC power for supplying it to the loads. The battery system is also connected to the external power grid through the power inverter, and possibly through other components as mentioned above.

Thus, the battery system may draw power from the external power grid or from a local power source such as a PV module as will be described further down. The battery system stores this power and may supply this stored power either to the external power grid or to loads of the building. The battery system is advantageously configured to be able to supply major appliances of a building with electrical power. In an advantageous embodiment, it may store at least 1 kWh (kilowatt hour) of electrical energy. More advantageously, it is configured to store at least 2 kWh, 5 kWh, 10 kWh or more of electrical energy. In particular, the battery system may be configured to store solar power from a solar panel installation or wind power from one or more wind turbines. Similarly, the power inverter is advantageously configured to be able to supply major appliances of a building with electrical power from the battery system. In an advantageous embodiment, it may allow a maximum output power of at least 1 kilowatts (kW), more advantageously, it is configured to allow a maximum output power of at least 1.5 kW, 2 kW, 2.5 kW, 3 kW, 4 kW, 5 kW, or 8 kW.

As mentioned before, the battery system is there to provide backup electrical power to the appliances through the first distribution board. In this case, the external power grid has to be disconnected from the first distribution board and, more crucially, from the battery system. This is necessary for safety reasons, in order to prevent power from the battery system to leak onto the external power grid, which at that time might be under repair by power company workers. For this purpose, a switching device is connected to said external power grid, to said power inverter and to said first distribution board, said switching device being configured to switch between an external power mode, in which electrical power to said first distribution board is drawn from said external power grid, and a backup power mode, in which electrical power to said first distribution board is drawn from said battery system.

This switching device may be implemented in form of two separate switches, the first of which is placed between the power inverter and the first distribution board and the second of which is placed between the external power grid and the first distribution board. In an alternative embodiment, the second switch of the switching device is integrated in the power inverter control system or in the battery control system, which is configured to disconnect the battery power from the first distribution board in cases where the power to the first distribution board is supplied by the external power grid.

However, in a more compact version, the switching device is a single switch having one input contact connected to the first distribution board and two output contacts connected to the external power grid and the power inverter, respectively. In this latter embodiment, said external power mode and said backup power mode are implemented as an external power position and an backup power position of the switch, respectively. The switching device may comprise a relay, which is controlled via a control connection, which is established in wire or as a remote connection.

An enclosure encloses said first distribution board and said power inverter. In other words, the first distribution board and the power inverter are located inside said enclosure. Said enclosure may be a frame structure housing the first distribution board and the power inverter. The frame structure may advantageously have panels that completely encase the first distribution board and the power inverter either all by themselves or with the help of a wall of the building, which then completes the encasing on the back side of the enclosure.

According to a further aspect of the invention, an energy distribution device is provided, comprising an enclosure, a first distribution board placed inside the enclosure and comprising multiple circuit breakers, for receiving electrical power and distributing said electrical power to multiple loads through said multiple circuit breakers, and a power inverter placed inside the enclosure and connected to said first distribution board for receiving electrical power from a battery system, transforming said received electrical power and supplying said transformed electrical power to said first distribution board.

Any of the necessary or optional features described above or further below in connection with the energy distribution system may also apply to the energy distribution device.

Having both the first distribution board and the power inverter placed inside said enclosure has the advantage that they can be delivered and installed at or inside the building by simply delivering said energy distribution device, placing it in the building and complete the wiring by making the necessary connections to the enclosure. The wiring between distribution board and the power inverter may already have been performed by the manufacturer of the energy distribution device or by an expert before delivery of the device at the building. This has the advantage of significantly speeding up the installation of a new energy distribution system and thus also of making it less costly. In addition, there is less likelihood for introducing errors in the wiring when setting up the system.

Therefore, according to yet another aspect of the invention, an installation method for installing an energy distribution system at a building is provided. The method comprises the following steps: placing an energy distribution device inside a building, said energy distribution device comprising an enclosure, a first distribution board placed inside the enclosure and comprising multiple circuit breakers, and a power inverter placed inside said enclosure and connected to said first distribution board for receiving electrical power from a battery system, transforming said received electrical power and supplying said transformed electrical power to said first distribution board; connecting at least one load or appliance to a corresponding one of said multiple circuit breakers of said distribution board; and connecting said first distribution board to an external power grid.

Advantageously, said enclosure is configured to be installed inside a building. In other words, the enclosure may be designed as a stand-alone structure that is transportable. Furthermore, it may comprise fastening means for fastening it to a wall of said building. Such fastening means may include screw holes, mounting holes, mounting rails etc.

In a possible embodiment, said enclosure may have means such as a socket or plug for electrically connecting a battery system to said power inverter. However, according to a preferred embodiment, said battery system is located inside said enclosure. This way, the additional space required for placing the battery system in the building next to or remote from the enclosure will be saved. Furthermore, there is no need for additional wiring work to connect the battery system to the power inverter, as this can also have been done when producing or assembling the energy distribution device.

According to a further advantageous embodiment, said switching device is located inside said enclosure. If the switching device comprises two or more separate switches, as explained above, it is possible that only one of the switches is inside the enclosure. For example, a switch between the first distribution board and the battery system or the power inverter may be placed alongside the power inverter inside the enclosure. Preferably, however, the entire switching device is placed inside the enclosure.

The first distribution board may be an open structure that is located inside the enclosure. I.e., the first distribution board is only enclosed by the enclosure, which also encloses the power inverter and optionally some other components. However, in an advantageous embodiment, said first distribution board comprises a first board enclosure, which is located inside said enclosure and which encloses said multiple circuit breakers. This first board enclosure will allow an electrical isolation of the circuit breakers of the first distribution board from the rest of the circuitry of the energy distribution device. The first board enclosure may be an integral part of the enclosure, or it may be an additional enclosure, which is attached to the inside of said enclosure.

In embodiments, where the first distribution board is the only distribution board of the energy distribution system, said first distribution board may be designated as the main panel of the system. When this first distribution board is disconnected from the external power grid, it has to be connected to a backup supply through the power inverter. Otherwise, all appliances of the building will be without power. In this case, it is possible to distinguish between essential and non-essential appliances or loads of the building by placing an appliance disconnector between the first distribution board and at least each non-essential appliance. While the essential appliances will receive their backup power through the main panel, each non-essential appliance can be electrically separated from the main panel by activating the corresponding appliance disconnector. This will be explained in more detail further below.

Alternatively or additionally, a second distribution board separate from said first distribution board may be provided, which second distribution board is connected to said external power grid and comprises at least one main circuit breaker. According to this embodiment, there are two distinct distribution boards. Now, the first distribution board may be designated as a sub-panel, while the second distribution board is designated as a main panel. In a backup power supply case, the backup device, namely the power inverter together with a battery system, will supply power only to the first distribution board, the sub-panel, while the second distribution board and all appliances, which are connected to the second distribution board and not to the first distribution board will not be supplied by the power inverter. Thus, essential or crucial appliances will have to be connected to the first distribution board. Essential or crucial appliances are those that have a high priority during a backup situation. In contrast, non-essential appliances may be switched off in a backup situation in order to cut down on the amount of backup power, and thus in order to preserve the power of the backup system for the essential appliances.

In an advantageous embodiment, said first distribution board and/or said switching device is connected to said external power grid through said second distribution board. This means that the second distribution board is electrically placed between the first distribution board and the external power grid and/or between the switching device and the external power grid. The first distribution board and/or switching device is advantageously connected to one of said least one main circuit breakers of the second distribution board. In other words, the main circuit breaker is connected to said power inverter and/or said distribution board, such that electrical power from said external power grid has to pass through said main circuit breaker to reach said distribution board.

Other systems and appliances may be connected to further main circuit breakers of the second distribution board directly. However, these will not profit from power provided by the power inverter of the energy distribution device.

In any of the embodiments described herein, one or more appliance disconnectors may be connected to the first or second distribution board, leading to an appliance or a group of appliances. Such an appliance disconnector is constructed to, when activated, stop electrical power flow to said appliance(s). This is useful in the case that a backup power system is in use, such as the power inverter in combination with the battery system, in which case said appliance will not drain electrical energy from the backup power system, which then has enough energy to support one or more further appliances that are more essential than the disconnected appliance(s).

Said appliance disconnector may be controlled by a microcontroller, as described further below. With the help of the appliance disconnector, an emergency power prioritization may be implement in order to supply backup power only to appliances that are deemed essential, while disconnecting all other appliances from the backup system. The appliance disconnector may be designed to disconnect an individual appliance such as an air conditioning system or a refrigerator, or it may be designed to disconnect multiple appliances at once, for example appliances located in a certain room or section of the building. Advantageously, said appliance disconnector is placed inside said first or second distribution board or inside a further distribution board of said building. The appliance disconnector may for example be a switchable fuse located inside a service panel of said building. In order to set up the energy distribution system, one may thus have to replace an already existing fuse inside the service panel or inside the distribution board with the switchable fuse, which then acts as an appliance disconnector.

Said appliance disconnector may alternatively be placed at or inside said appliance, which it is supposed to disconnect. For example, the appliance disconnector may be a device put between the power cord of the appliance and a wall socket.

In a preferred embodiment, said appliance disconnector is controlled remotely. This may be achieved via a radio signal or via a wireless local area network connection. This has the advantage of simplifying the installation costs and efforts significantly. The appliance disconnector may be part of a building automation system, which controls a number of appliances or all appliances in the building. In case of automated or intelligent appliances, the appliance disconnector may be part of a control system of the appliance.

According to an especially compact embodiment, said second distribution board is located inside said enclosure of the energy distribution device. In other words, the enclosure encloses both the first and the second distribution board. Advantageously, said second distribution board is enclosed inside a second board enclosure, which is located inside said enclosure. This may be advantageous, even if the first distribution board is not located inside a first board enclosure as suggested above. Alternatively, the second distribution board may be located outside of said enclosure of the energy distribution device. In addition, in this case, the second distribution board may be enclosed inside a second board enclosure, which then would be placed outside of said enclosure to electrically isolate the main circuit breakers from the environment.

The energy distribution system may comprise one, two or more alternative energy sources such as photovoltaic devices, wind turbines or the like. Preferably, a first photovoltaic device is connected to said first distribution board for supplying electrical power to said multiple loads through said corresponding one of said multiple circuit breakers. The connection of the first photovoltaic device is preferably made between the switching device and the first distribution board, such that the first photovoltaic device can supply power to the first distribution board even when the switching device is switched to the power inverter. The first photovoltaic device in this embodiment can be regarded as an off-grid photovoltaic device.

According to an advantageous embodiment of the energy distribution system, a second photovoltaic device is connected to said external power grid and said battery system and configured to supply said external power grid and/or said battery system with solar power. In this case, the second photovoltaic device is connected to the external power grid side of said switching device. The second photovoltaic device in this embodiment may be regarded as an on-grid photovoltaic device. Despite the terminology of first and second photovoltaic device, the energy distribution system might be provided by only one such photovoltaic device, namely either of the first or the second type.

The energy distribution device may include a microcontroller. Said microcontroller is advantageously placed inside said enclosure. The microcontroller is connected to and controls said switching device. Depending on the state of the external power grid, on the states of possible photovoltaic devices or other power sources connected to the energy distribution device as part of the energy distribution system, on the state of the power inverter and/or the battery system, and/or on the state of appliances feeding from the energy distribution system, the microcontroller is able to control said switching device in order to connect the first distribution board to the external power grid or to the power inverter for receiving backup power. Different power meters may be placed on various sites in the energy distribution system for obtaining a measure of the state of the external power grid, of the states of possible photovoltaic devices or other power sources connected to the energy distribution device as part of the energy distribution system, of the state of the power inverter and/or the battery system, and/or of the state of appliances feeding from the energy distribution system.

Said microcontroller may be part of a programmable logic controller (PLC), which is part of the energy distribution system and preferably placed inside said enclosure of the energy distribution device. When said energy distribution device comprises a microcontroller placed inside said enclosure, said installation method may comprise the steps of connecting said microcontroller to an appliance disconnector, which is electrically placed between said load and said corresponding circuit breaker. Additionally or alternatively, the method my comprise programming said microcontroller to activate said appliance disconnector when said energy distribution system is in a backup mode, whereby said first distribution board receives electrical power from said power inverter. The step of programming the microcontroller may be performed by initiating an installation program.

The energy distribution device may advantageously comprise one or more of the following elements and components: Terminal lugs for connecting wires coming from the external power grid; busbars with anchoring means for holding circuit protection devices such as fuses, relays and/or circuit breakers; busbars for the neutral phase; grounding lugs and busbars; and inlet holes for wires.

### BRIEF DESCRIPTION OF THE DRAWINGS

The present invention will be explained in more detail in the following text with reference to preferred embodiments of an energy supply system according to the invention, which are illustrated in FIG. 1 through FIG. 4 and are not intended to be restrictive.

FIG. 1 is a schematic wiring diagram of an energy distribution system according to a first embodiment of the invention, wherein a first distribution board and a power inverter are placed inside a joint enclosure.

FIG. 2 is a schematic wiring diagram of an energy distribution system according to a second embodiment of the invention, wherein a first distribution board, a second distribution board and a power inverter are placed inside a joint enclosure.

FIG. 3 is a schematic wiring diagram of an energy distribution system according to a second embodiment of the invention, wherein a first distribution board and a power inverter are placed inside a joint enclosure, while a second distribution board is placed next to the enclosure.

### DETAILED DESCRIPTION

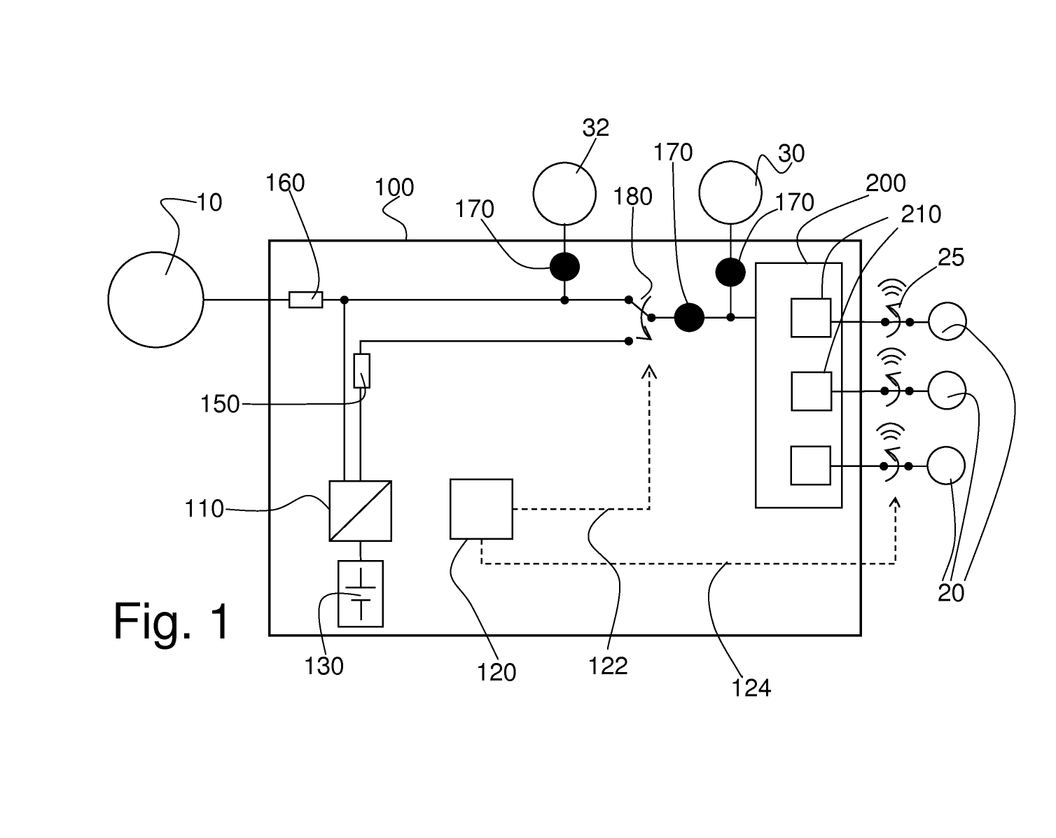

FIG. 1 shows a schematic wiring diagram of an energy distribution system of a building. The system comprises an energy distribution device, which comprises a number of components placed in an enclosure 100. The components of the energy distribution device are a first distribution board 200, which is made up of a number of first circuit breakers 210, which are enclosed inside a first board enclosure. In FIG. 1, only three exemplary first circuit breakers 210 are shown, while a first distribution board 200 may contain up to 20 or even 30 to 40 or more circuit breakers.

Each of the first circuit breakers 210 is connected to an appliance or load 20, which is located inside or about the building. The first circuit breakers 210 may in particular be fuses. Between each first circuit breaker 210 and the corresponding load 20, an appliance disconnector 25. An arrow visualizes that the appliance disconnector 25 is configured to disconnect the corresponding load 20 from the first distribution board 200, and thus from the power supply. For this purpose, the appliance disconnector 25 receives a remote control signal, which is visualized by three concentric arcs above each appliance disconnector 25.

The energy distribution device further comprises a power inverter 110 and a battery system 130 connected to the power inverter 110, both placed inside the enclosure 100 alongside the first distribution board 200. The power inverter 110 converts the direct current power from the battery system 130 to an alternative current power for supplying it to the first distribution board 200 and ultimately to the loads 20. A switching device 180 is placed before the first distribution board 200. The switching device 180 has two switching modes, between which it can switch. When in a backup power mode, electrical power from the power inverter 110 may flow to the first distribution board 200. When in an external power mode, electrical power to said first distribution board 200 is drawn from an external power grid 10, to which a further contact of the switching device 180 is connected. This connection leads out of the enclosure and connects to a wall socket, which is not shown in the figures, in order to provide a connection to the external power grid 10.

The switching device 180 is controlled by a microcontroller 120, which is part of a programmable logic controller (PLC). The microcontroller 120 controls the switching device by way of a switching signal 122, which is transmitted to the switching device 180 via a wireless connection. Another signal connection is for sending disconnecting signals 124 from the microcontroller 120 to one or more of the appliance disconnectors 25 in order to disconnect a load 20 from power coming through the switching device 180.

The energy distribution system shown in FIG. 1 further comprises two photovoltaic devices 30, 32. A first photovoltaic device 30 is connected directly to the input of the first distribution board 200 in order to supply off-grid photovoltaic power to the loads 20 even when there is no power coming from the external power grid 10. The first photovoltaic device 30 and the power inverter 110 together with the battery system 130 may form a backup system for ensuring seamless supply of electrical power to the loads in case of a power outage at the external grid 10. The microcontroller 120 is programmed to activate any of the appliance disconnectors 25 and thus disconnect non-critical or non-essential loads 20 from this backup system in order to ensure that only critical or essential loads receive backup power.

A second photovoltaic device 32 is connected to the contact of the switching device 180 that is connected to the external power grid 10. The second photovoltaic device 32 works as an on-grid system, and can provide power to the external power grid 10 is necessary, in particular for generating revenue for the owner. The first photovoltaic device 30 and the second photovoltaic device 32 can also supply power to the power inverter 110, which can convert this power for storage in the battery system 130.

The microcontroller 120 may receive input from power meters, which may be located anywhere in the energy distribution system. In FIG. 1, three such power meters 170 are shown. One is monitoring the output of the first photovoltaic device 30, another one is monitoring the second photovoltaic device 32, and a third power meter 170 is monitoring the power coming through the switching device 180. The latter power is either the power coming from the external power grid 10, if the switching device 180 is in external power mode, or the power supplied by the power inverter 110, is switching device 180 is in backup power mode. By monitoring the power meters 170, the microcontroller can detect a power loss of the external power grid 10. Consecutively, it can switch the switching device 180 from external power mode to backup power mode. Other power meters (not shown) may be connected directly to the external power grid in order to detect the re-emergence of power at the power grid 10 and consecutively switch the switching device 180 back to external power mode is so desired.

Also shown in FIG. 1, are a backup power fuse 150, protecting the system from a current surge coming from the power inverter 110, and an external power fuse 160, protecting the system from a current surge coming from the external power grid 10. The backup power fuse 150 may be configured for about 30 Ampere (A), while the external power fuse 160 is advantageously configured for much higher current, e.g. for 200 A. In order to be able to charge the battery system 130, the first photovoltaic device 30 has to be configured to not exceed the maximum current of the backup power fuse 150. In alternative embodiments, the backup power fuse 150 and/or the external power fuse 160 may be replaced by other circuit breaker devices, such as relays, in particular protective relays, or remote controlled relays, or remote controlled switches.

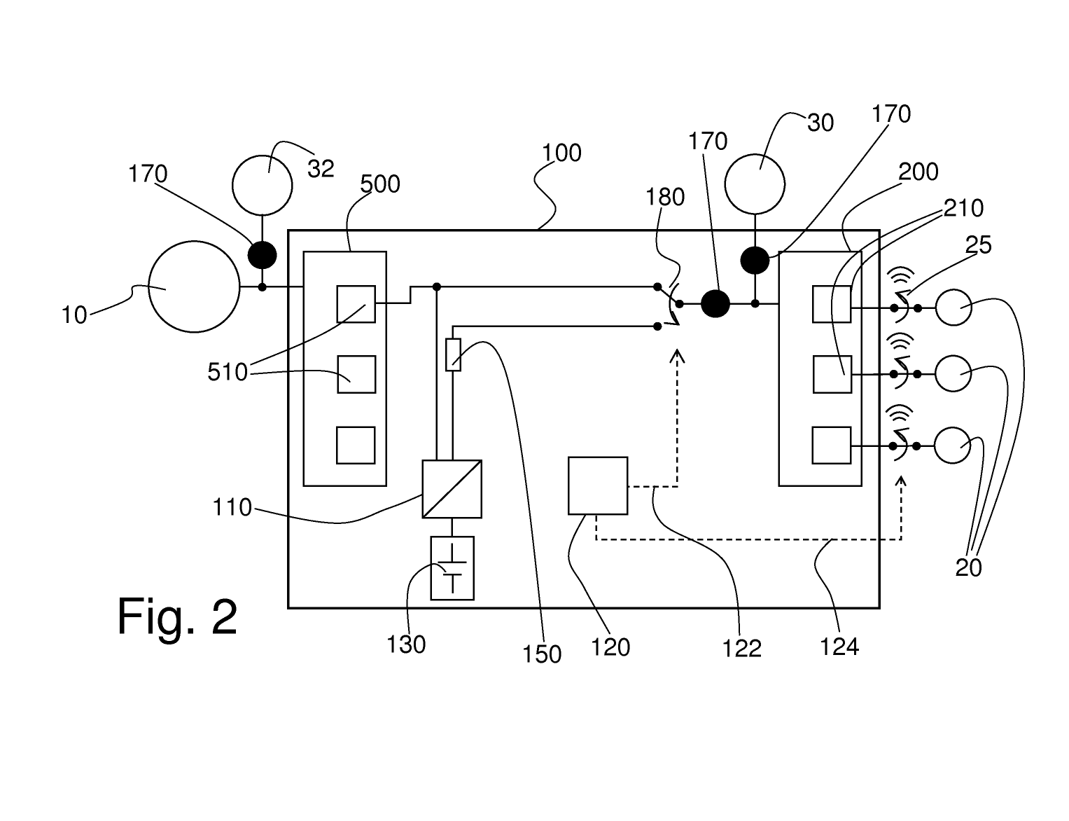

Instead of the external power fuse 160, the connection from the external power grid 10 to the switching device 180 may extend through a main circuit breaker 510 of a second distribution board 500. One embodiment of this situation is shown in FIG. 2. Herein, the second distribution board 500 is located inside the enclosure 100 of the energy distribution device. The second distribution board 500 may be further enclosed by a second board enclosure. It comprises further main circuit breakers 510, which can be connected to further appliances, which are non-essential and thus have a lower priority than the loads 20 shown in FIG. 2. These non-essential appliances will not receive backup power when there is an outage at the external power grid 10.

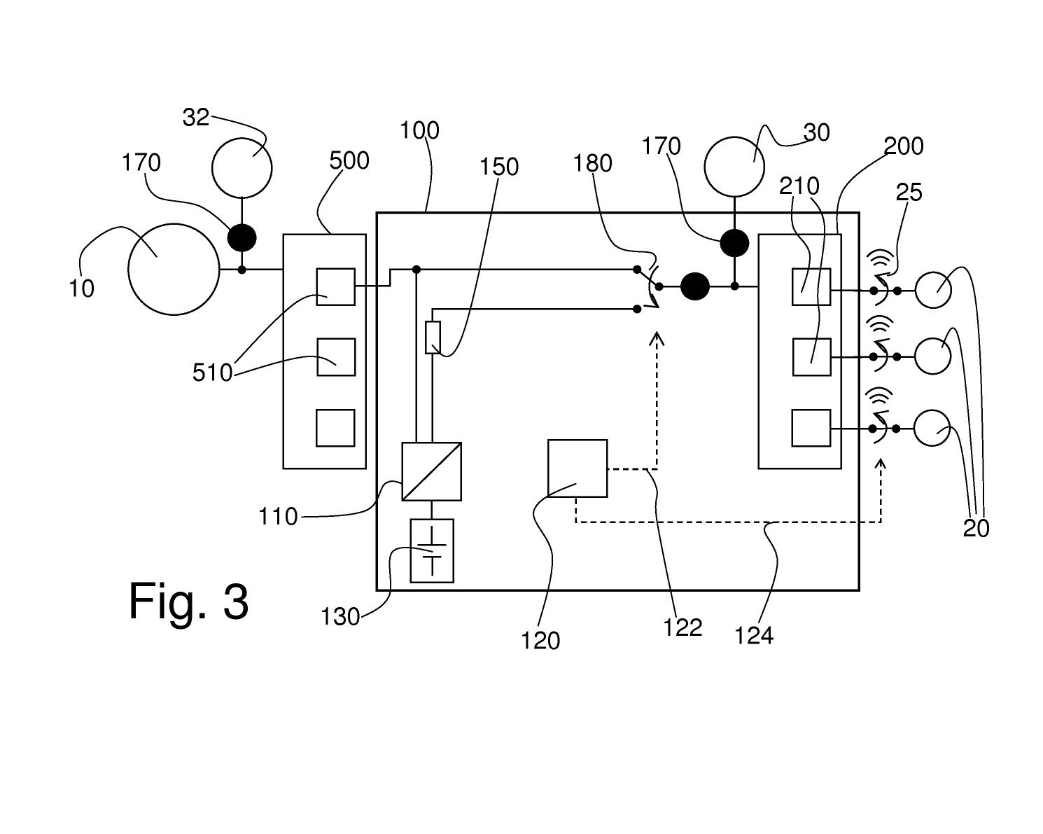

Furthermore, the second photovoltaic device 32 is now connected to the external power grid 10 on the outside of the enclosure 100, while this connection is leading through the enclosure 100 in the embodiment shown in FIG. 1. The other components and elements of FIG. 2 correspond to the ones shown in FIG. 1 and described above. In the embodiment of FIG. 2, as with the one of FIG. 3 described below, the second distribution board 500 may be configured as a main panel, while the first distribution board 200 is configured as a sub-panel.

In the embodiment of the energy distribution system shown in FIG. 3, the second distribution board 500 is located outside of the enclosure 100. It may be located next to the enclosure 100 of the energy distribution device. The other components and elements of FIG. 3 correspond to the ones shown in FIG. 1 and FIG. 2 and described above. As described above, the second distribution board 500 may be regarded as a main panel. It can be already installed in the building prior to installation of the energy distribution system, which may be accomplished by placing the enclosure 100 of the energy distribution device in or at the building and making the necessary connections. In addition, the microcontroller 120 may be programmed to manage and control the energy distribution system, e.g. to monitor the power meters 170 and to control the switching device 180, the appliance disconnectors 25 and possibly further components, such as the battery system and/or the power inverter.

In all embodiments described above, the battery system 130 may comprise several batteries and components for managing the storage and delivery of electrical power from these batteries. The power inverter 110 may also comprise the appropriate power management components. Furthermore, the enclosure comprises connection lugs for connecting the external power grid 10, the photovoltaic devices 30, 32 and the loads 20 to the energy distribution device. In the embodiments shown in the figures, the battery system 130 is already placed inside the enclosure 100. When assembling the energy distribution device, the battery system 130 may be omitted at first. Instead, fastening and connection means may be provided inside the enclosure 100 for fastening the battery system 130 and connecting it to the energy distribution system upon delivery and installation of the energy distribution device at the building.

Alternatively, when the battery system 130 is not meant to be placed inside the enclosure 100, the enclosure may comprise connecting means for electrically connecting the battery system 130 as an external battery system to the power inverter 110.

### REFERENCE NUMERALS

10 external power grid
20 load
25 appliance disconnector
100 enclosure
110 power inverter
120 microcontroller
122 switching signal
124 disconnecting signal
130 battery system
150 backup power fuse
160 external power fuse
180 switching device
200 first distribution board
210 first circuit breaker
500 second distribution board
510 main circuit breaker

1. An energy distribution system for a building, comprising:
a first distribution board comprising multiple circuit breakers, wherein said first distribution board is connected to an external power grid and to multiple loads, such that each of said multiple loads receives electrical power from said external power grid through a corresponding one of said multiple circuit breakers;
a power inverter connected to said first distribution board;
a battery system connected to said power inverter and configured to store excess electrical power and to supply stored electrical power to said multiple loads through said power inverter;
a switching device connected to said external power grid, to said power inverter and to said first distribution board, said switching device being configured to switch between an external power mode, in which electrical power to said first distribution board is drawn from said external power grid, and a backup power mode, in which electrical power to said first distribution board is drawn from said battery system; and
an enclosure enclosing said first distribution board and said power inverter.

2. The energy distribution system according to claim 1, wherein said battery system and/or said switching device is located inside said enclosure.

3. The energy distribution system according to claim 1, wherein said first distribution board comprises a first board enclosure located inside said enclosure, which first board enclosure encloses said multiple circuit breakers.

4. The energy distribution system according to claim 1, comprising a second distribution board separate from said first distribution board, which second distribution board is connected to said external power grid and comprises at least one main circuit breaker.

5. The energy distribution system according to claim 4, wherein said first distribution board and/or said switching device is connected to said external power grid through said second distribution board.

6. The energy distribution system according to claim 4, wherein said second distribution board is located inside said enclosure.

7. The energy distribution system according to claim 6, wherein said second distribution board is enclosed inside a second board enclosure, which is located inside said enclosure.

8. The energy distribution system according to claim 4, wherein said main circuit breaker is connected to said power inverter and/or said distribution board, such that electrical power from said external power grid has to pass through said main circuit breaker to reach said distribution board.

9. The energy distribution system according to claim 1, wherein a first photovoltaic device is connected to said first distribution board for supplying electrical power to said multiple loads through said corresponding one of said multiple circuit breakers.

10. The energy distribution system according to claim 1, wherein a second photovoltaic device is connected to said external power grid and said battery system and configured to supply said external power grid and/or said battery system with solar power.

11. An energy distribution device comprising:
an enclosure;
a first distribution board placed inside the enclosure and comprising multiple circuit breakers, for receiving electrical power and distributing said electrical power to multiple loads through said multiple circuit breakers;
a power inverter placed inside the enclosure and connected to said first distribution board for receiving electrical power from a battery system, transforming said received electrical power and supplying said transformed electrical power to said first distribution board.

12. The energy distribution device according to claim 11, wherein said enclosure is configured to be installed inside a building.

13. The energy distribution device according to claim 12, wherein said enclosure comprises fastening means for fastening it to a wall of said building.

14. The energy distribution device according to claim 11, wherein a switching device is placed inside said enclosure, said switching device being configured to switch between an external power mode, in which electrical power to said first distribution board is drawn from an external power grid, and a backup power mode, in which electrical power to said first distribution board is drawn from said power inverter.

15. The energy distribution device according to claim 11, wherein a microcontroller is placed inside said enclosure, the microcontroller being connected to and controlling said switching device.

16. An installation method for installing an energy distribution system at a building, comprising the following steps:
Placing an energy distribution device inside a building, said energy distribution device comprising an enclosure, a first distribution board placed inside the enclosure and comprising multiple circuit breakers, and a power inverter placed inside said enclosure and connected to said first distribution board for receiving electrical power from a battery system, transforming said received electrical power and supplying said transformed electrical power to said first distribution board;
Connecting at least one load to a corresponding one of said multiple circuit breakers of said distribution board; and
Connecting said first distribution board to an external power grid.

17. The installation method according to claim 16, wherein said energy distribution device comprises a microcontroller placed inside said enclosure, further comprising the steps of connecting said microcontroller to an appliance disconnector, which is electrically placed between said load and said corresponding circuit breaker, and programming said microcontroller to activate said appliance disconnector when said energy distribution system is in a backup mode, whereby said first distribution board receives electrical power from said power inverter.
